(19) United States
(12) Patent Application Publication
(10) Pub. No.: US 2023/0044229 A1
(43) Pub. Date: Feb. 9, 2023

(54) BATTERY HEADER CAP AND ASSEMBLY METHOD THEREOF

(71) Applicant: Advanti Co., Ltd., Tainan City (TW)

(72) Inventors: HUNG-WEI LIN, Taichung City (TW); PIN-HUNG HSU, Tainan City (TW); GUAN-YU CHEN, Kaohsiung City (TW); GUO-CHEN HUANG, Tainan City (TW)

(21) Appl. No.: 17/818,487

(22) Filed: Aug. 9, 2022

Related U.S. Application Data
(60) Provisional application No. 63/260,093, filed on Aug. 9, 2021.

(51) Int. Cl. H01M 50/152; H01M 50/107; H01M 50/169

(52) U.S. Cl. CPC H01M 50/152; H01M 50/107; H01M 50/169

(57) ABSTRACT

A battery header cap and an assembly method thereof are provided, and the battery header cap includes a battery, a battery header, an insulating sleeve, and a header cap. The battery includes a battery body and a battery case, and the battery case has a header groove near a case opening. The battery header is disposed at the case opening, and the insulating sleeve completely covers the metal surface of the battery header cap. The header cap includes an electrode plane and a sidewall, the electrode plane has a header cap opening to expose the metal electrode, the electrode plane is disposed on the insulating sleeve, the sidewall covers the end of the battery case, and the end of the sidewall is embedded into the header groove. The structure provides support and insulating protection for the header and also enhances the sealability of the case.

### CROSS-REFERENCE TO RELATED APPLICATION

This application claims priority from U.S. Patent Provisional Application No. 63/260,093, filed on Aug. 9, 2021, in the United States Patent and Trademark Office, the content of which is hereby incorporated by reference in its entirety for all purposes.

### BACKGROUND OF THE INVENTION

### 1. Field of the Invention

The present disclosure relates to a battery header cap and an assembly method thereof, more particularly to a battery header cap and an assembly method thereof that can enhance structural stability and safety through an insulating sleeve and a header cap structure and improve the convenience and yield rates of the soldering process.

### 2. Description of the Related Art

When making a series-parallel module of several batteries, it is often necessary to connect electrodes of batteries in series to form a required module structure. Generally, provided that the electrodes of the batteries are positioned at each end, it is required to solder electrode pieces to each other to achieve the effect of a series connection. The way of soldering both sides not only has material costs but also increases manpower and time required in the process as well as production costs.

Therefore, when battery module manufacturers make relevant series-parallel battery modules, to speed up the production of automated production lines, it is often necessary to perform series connections of electrodes via adopting the soldering method of positive and negative electrodes on the same side. However, in terms of cylindrical-shaped batteries, the soldering points on the shoulder of the batteries are often rounded edges, which fails to provide sufficient soldering areas, resulting in soldering difficulties or an increase in impedance. In a soldering process, due to the closeness of contact points and sealing structures, a high-temperature operation would easily make the header cap sealing structure defective, leading to battery liquid leakage that damages modules.

Accordingly, the inventor of the present disclosure has designed a battery header cap and an assembly method thereof in an effort to tackle deficiencies in the prior art and further enhance the implementation and application in industries.

### SUMMARY OF THE INVENTION

In view of the aforementioned conventional problem, the present disclosure provides a battery header cap and an assembly method to solve the problem of soldering difficulty when battery modules are connected in series and of the sealing structure easily affected in the prior art.

According to one objective of the present disclosure, a battery header cap is provided, including a battery, a battery header, an insulating sleeve, and a header cap. Wherein, the battery includes a battery body and a battery case, the battery body is disposed inside the battery case through a case opening, and the battery case has a header groove near the case opening. A battery header is disposed at the case opening, and the battery header has a metal electrode and a metal surface electrically connected to the metal electrode. An insulating sleeve completely covers the metal surface of the battery header, and the outer diameter of the insulating sleeve corresponds to the size of the case opening. A header cap includes an electrode plane and a sidewall, the electrode plane has a header cap opening to expose the metal electrode, the sidewall is vertically connected to an end of the electrode plane, the electrode plane is disposed on the insulating sleeve, the sidewall covers an end of the battery case, and an end of the sidewall is embedded into the header groove.

Preferably, the electrode plane may be disposed with a raised edge at an edge of the header cap opening, and the raised edge extends in an opposite direction of the header cap opening.

Preferably, a bump may be disposed on the electrode plane, and the bump is disposed between an end of the header cap and the header cap opening.

Preferably, the battery case may be a cylindrical case.

Preferably, the electrode plane may be connected to the battery case, which has an opposite polarity to the metal electrode.

According to another objective of the present disclosure, an assembly method of a battery header cap is provided, including the following steps: providing a battery, a battery header, an insulating sleeve, and a header cap, the battery including a battery body and a battery case, the battery case having a header groove near a case opening, and the header cap including an electrode plane and a sidewall; covering a metal surface of the battery header completely with the insulating sleeve and forming a header insulating sleeve set through thermal pressing; disposing the header insulating sleeve set at the case opening and performing a shrinking and sealing process to recess an end of the battery case so as to fix the header insulating sleeve set; disposing the header cap on the case opening, disposing the electrode plane on the header insulating sleeve set, and covering the battery case and part of the header groove by the sidewall; embedding an end of the sidewall into the header groove through a cold working process to fix the header cap onto the battery case.

Preferably, the electrode plane may be disposed with a raised edge at an edge of a header cap opening of the header cap, and the raised edge and the electrode plane are soldered to an electrode connecting piece.

Preferably, a bump may be disposed on the electrode plane, and the bump and the electrode plane are soldered to an electrode connecting piece.

Preferably, the battery body may be disposed inside the battery case of a cylindrical case.

Preferably, by adjusting a height of the electrode plane, the cold working process makes the height of the electrode plane no higher than that of a metal electrode of the battery header.

As mentioned above, the battery header cap and the assembly method thereof of the present disclosure have one or more advantages as follows:

(1) The battery header cap and the assembly method thereof may enhance the support of the bottom of the header cap and strengthen the sealability of a battery, thus inhibiting the damage caused by the thermal effect of soldering. By adopting the header insulating sleeve set to accomplish the battery shrinking and sealing process, the diameter of the shoulder of the header may be adjusted at the same time so as to achieve the requirement for a full battery closure, which ensures complete sealability of the battery and effectively blocks leakage of battery fluid.

(2) The battery header cap and the assembly method thereof may embed the sidewall into the groove on the battery header groove; with the combination of the header cap and the header insulating sleeve set, fine sealability and support may be provided for the header, which not only maintains the insulating and sealing structure of the original shoulder of the battery but also enhances the fixing force of the header on the battery; this effectively prevents the risk of the header being ejected for a battery that burns and explodes at high temperatures.

(3) The battery header cap and the assembly method thereof may add a flat area on the negative electrode on the top surface of the battery, which provides a steady plane when batteries are connected in series or in parallel to form a battery module on an automated production line and greatly improves the quality and quantity by automatic soldering. The header cap does not affect the size of a battery, such as the width of the outer diameter of a battery, overall height, and other important specifications; it is also possible to adjust the appearance according to the production requirements so as to provide the needs of special design for a mechanism or contact assembly.

### BRIEF DESCRIPTION OF THE DRAWINGS

To make the technical features, content, and advantages of the present disclosure and the achievable effects more obvious, the present disclosure is described in detail together with the drawings and in the form of expressions of the embodiments as follows:

FIG. 1A and FIG. 1B are structural schematic diagrams of the battery header cap according to an embodiment of the present disclosure.

FIG. 2 is an exploded schematic diagram of the battery header cap according to an embodiment of the present disclosure.

FIG. 3 is a schematic diagram of the header cap according to an embodiment of the present disclosure.

FIG. 4A, FIG. 4B, and FIG. 4C are schematic diagrams of the header cap according to another embodiment of the present disclosure.

FIG. 5 is a schematic diagram of the header cap according to yet another embodiment of the present disclosure.

FIG. 6A, FIG. 6B, and FIG. 6C are schematic diagrams of the insulating sleeve according to an embodiment of the present disclosure.

FIG. 7A, FIG. 7B, and FIG. 7C are schematic diagrams of the header insulating sleeve set according to an embodiment of the present disclosure.

FIG. 8 is a flowchart of the assembly method of the battery header cap according to an embodiment of the present disclosure.

### DESCRIPTION OF THE PREFERRED EMBODIMENTS

To illustrate the technical features, contents, advantages, and achievable effects of the present disclosure, the embodiments together with the attached drawings are described in detail as follows. However, the drawings are used only for the purpose of indicating and supporting the specification, which is not necessarily the real proportion and precise configuration after the implementation of the present disclosure. Therefore, the relations of the proportion and configuration of the attached drawings should not be interpreted to limit the actual scope of implementation of the present disclosure.

All terms used herein (including technical and scientific terms) have the meanings commonly understood by a person with ordinary skill in the art. It should be further understood that, unless explicitly defined herein, the terms such as those defined in commonly used dictionaries should be interpreted as having definitions consistent with their meaning in the context of the related art and the present disclosure, and should not be construed as idealized or overly formal.

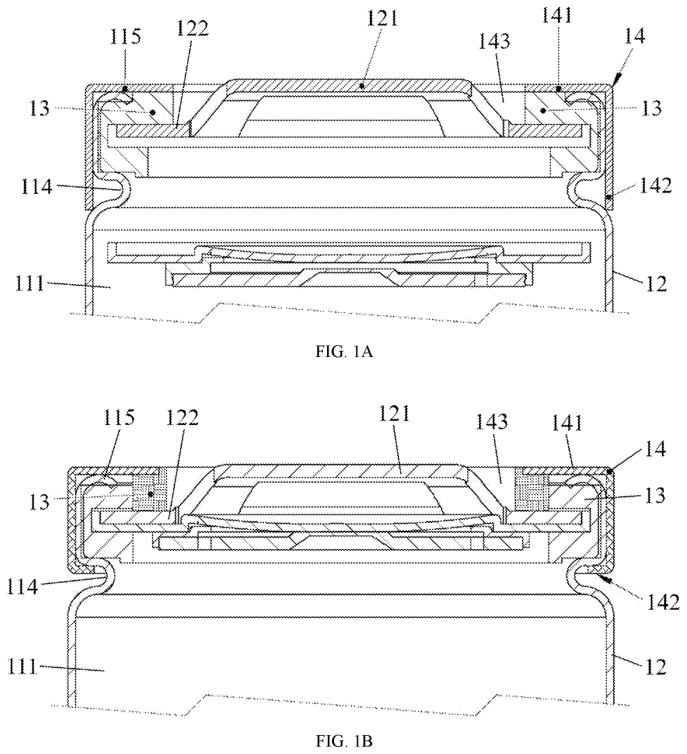

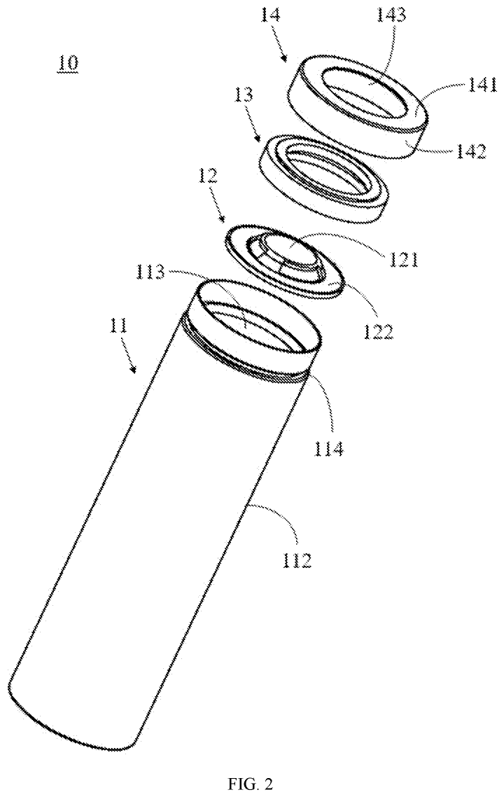

Please refer to FIG. 1A and FIG. 1B, which are structural schematic diagrams of the battery header cap according to an embodiment of the present disclosure; particularly, FIG. 1A is a schematic diagram of the header cap disposed at the case opening, and FIG. 1B is a schematic diagram of the header cap fixed to the battery through the cold working process. Please refer to FIG. 2 at the same time, which is an exploded schematic diagram of the battery header cap according to an embodiment of the present disclosure. As shown in the figures, the battery header cap 10 includes a battery 11, a battery header 12, an insulating sleeve 13, and a header cap 14. The battery 11 includes a battery body 111 and a battery case 112, the battery body 111 is disposed inside the battery case 112 through a case opening 113, and the battery case 112 has a header groove 114 near the case opening 113. The battery case 112 may be a cylindrical or cylindrical-shaped case made of metal, the side of the case near the case opening 113 has a recessed header groove 114, and the end of the case on the header groove 114, which is the shoulder of the battery case 112, may be recessed into the opening through the shrinking and sealing process, which is used to fix the battery header 12 and as the case electrode 115 through the recessed plane. However, as described in the prior art, during the shrinking and sealing process, the case electrode 115 may have a certain radian, making the soldering area as the electrode plane smaller, resulting in soldering difficulties or an increase in impedance. Therefore, the present disclosure further discloses the structures of the battery header 12, the insulating sleeve 13, and the header cap 14.

The battery header 12 is disposed at the case opening 113, and the battery header 12 has a metal electrode 121 and a metal surface 122 electrically connected to the metal electrode 121; the metal electrode 121 is a protruding structure, and the metal surface is connected to the battery body 111. The metal electrode 121 and the case electrode 115 respectively are electrodes with different polarities in the battery; for example, the metal electrode 121 is the positive electrode and the case electrode 115 is the negative electrode, but the present disclosure is not limited thereto; the polarities of the electrodes may also be reversed according to the internal design of battery body 111. The metal electrode 121 and the case electrode 115 are disposed at the same end; the same-side soldering method may be adopted to accelerate the production of the automated production line when multiple batteries are formed into a series-parallel battery module. However, when the positive and negative electrodes are on the same side and adjacent to each other, the insulation between the electrodes becomes even more important; therefore, the present disclosure utilizes the insulating sleeve 13 to completely cover the metal surface 122 of the battery header 12 so that the metal surface 122 may be insulated from the battery case 112, which avoids the problem of the battery case 112 making contact with the battery header 12 during the shrinking and sealing process, resulting in a short circuit. In addition, the insulating sleeve 13 may also increase the sealability of the battery header 12; this prevents structural defects stemming from high temperature in the subsequent soldering process, which would lead to the problem of battery leakage. The outer diameter of the insulating sleeve 13 corresponds to the size of the case opening 113, so that the battery header 12 and the insulating sleeve 13 may be disposed exactly at the case opening 113; through the shrinking and sealing process, the end of the battery case 112 is recessed into the insulating sleeve 13 to secure the entire battery header 12 and insulating sleeve 13; meanwhile, the diameter size or overall height of the battery tip is adjusted to achieve the requirement for battery sealing.

The header cap 14 includes an electrode plane 141 and a sidewall 142, the electrode plane 141 has a header cap opening 143 to expose the metal electrode 121, and the sidewall 142 is vertically connected to the end of the electrode plane 141; as shown in FIG. 1A, the electrode plane 141 is disposed on the insulating sleeve 13, the electrode plane 141 makes contact with the case electrode 115, and the case electrode 115 is replaced by the electrode plane 141 to form an electrode structure with a flat and large area, which provides enough contact space, increases soldering joints when multiple batteries are soldered with electrode connecting pieces, improves soldering quality, and reduces joint impedance. Moreover, the contact points are far away from the shoulder of the battery to inhibit damage caused by the thermal effect of soldering, thus improving the efficiency of module production. The sidewall 142 covers the end of the battery case 112, and the end of the sidewall 142 partially or completely exceeds the header groove 114. After the cold working process, as shown in FIG. 1B, the end of the sidewall 142 is embedded into the header groove 114 so that the header cap 14 is fixed onto the battery case 112; the header cap 14 combined with the insulating sleeve 13 and the battery header 12 may provide fine sealability and support for the header, which not only maintains the insulating and sealing structure of the original shoulder of the battery but also enhances the fixing force of the header cap 14 on the battery; this effectively prevents the risk of the header being ejected for a battery that burns and explodes at high temperatures.

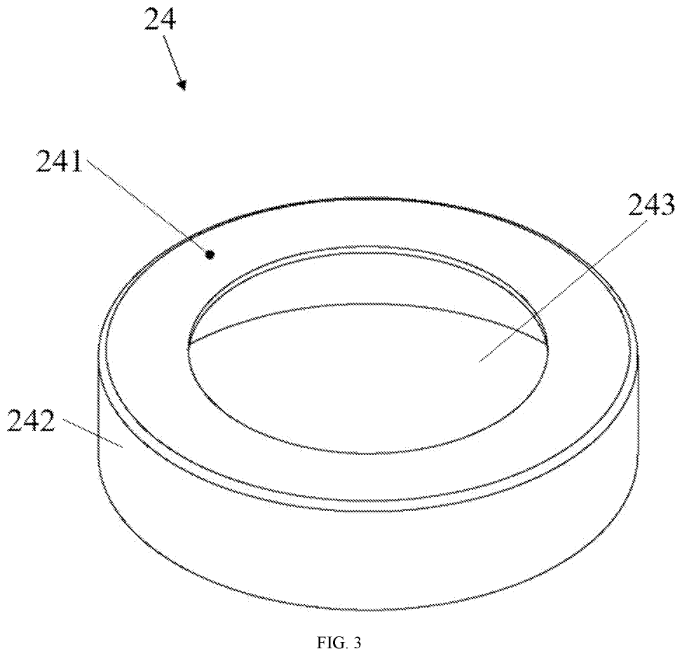

Please refer to FIG. 3, which is a schematic diagram of the header cap according to an embodiment of the present disclosure. As shown in the figure, the header cap 24 includes an electrode plane 241 and a sidewall 242, which may be made of the same conductive material as the battery case 112. The electrode plane 241 is a ring-shaped structure with a header cap opening 243, and the header cap opening 243 has an opening size larger than the metal electrode 121 of the battery header 12; when the header cap 24 is disposed on the battery header 12, the metal electrode 121 may be exposed from the opening. The outer diameter of the ring-shaped structure corresponds to the battery case 112, which is slightly larger than the case opening 113 to allow the header cap 24 to be sleeved on the top end of the battery case 112; the sidewall 242 of the header cap 24 extends vertically from the outer edge of the electrode plane 241, and the height of the sidewall 242 is adjusted according to the position of the header groove 114 of the battery case 112 so that the end of the sidewall 242 may reach the position of the header groove 114.

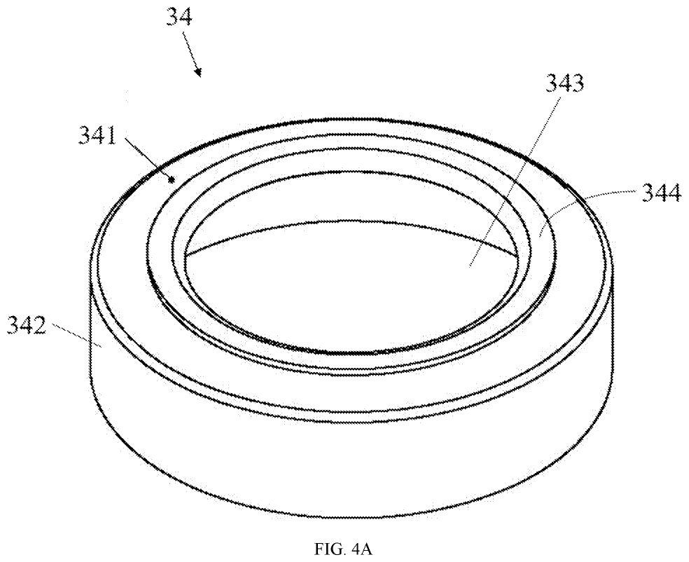

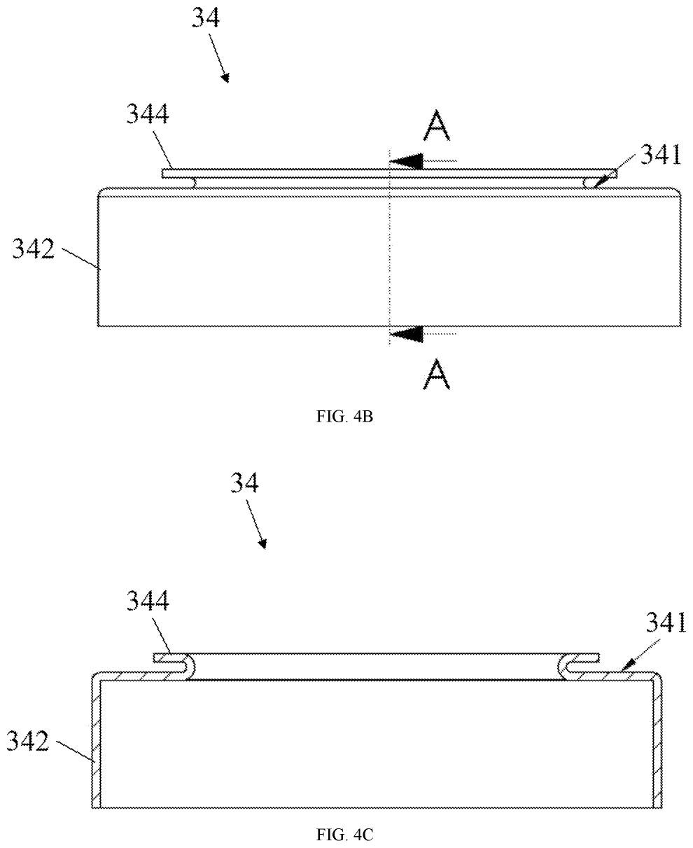

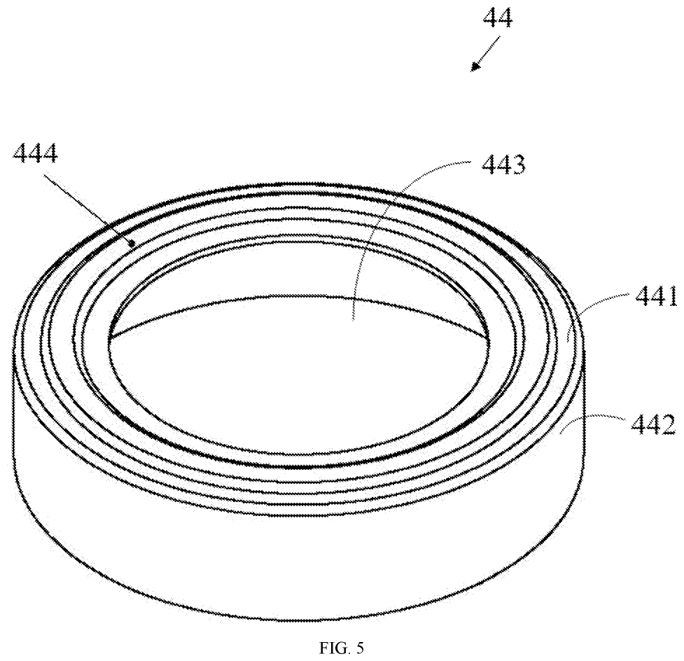

Please refer to FIG. 4A, FIG. 4B, and FIG. 4C, which are schematic diagrams of the header cap according to another embodiment of the present disclosure, wherein FIG. 4A is a three-dimensional view of the header cap, FIG. 4B is a side view of the header cap, and FIG. 4C is a cross-sectional view of the header cap along the dotted line A in FIG. 4B. As shown in the figure, the header cap 34 includes an electrode plane 341 and a sidewall 342, the electrode plane 341 is a ring-shaped structure with a header cap opening 343, the electrode plane 341 is disposed with a raised edge 344 at an edge of the header cap opening 343, and the raised edge 344 extends in the opposite direction of the header cap opening 343. The disposition of the raised edge 344 may increase the soldering joints of the electrode connecting piece during the soldering process, thus increasing soldering stability and improving soldering quality. The height of the raised edge 344 and the length of its outward extension may be adjusted according to the battery design or soldering requirements, which does not exceed the height of the metal electrode and the original width of the battery in principle; however, the present disclosure is not limited thereto, and in other embodiments, the height and length may be increased or decreased as needed.

Please refer to FIG. 5, which is a schematic diagram of the header cap according to yet another embodiment of the present disclosure. As shown in the figure, the header cap 44 includes an electrode plane 441 and a sidewall 442, the electrode plane 441 is a ring-shaped structure, a bump 444 may be disposed on the electrode plane 441, and the bump 444 is disposed between the end of the header cap 44 and the header cap opening 443. Similar to the aforementioned embodiment, the disposition of the bump 444 may increase the soldering joints of the electrode connecting piece during the soldering process, thus increasing soldering stability and improving soldering quality. The height of the bump 444 and the width of the bump 444 may be adjusted according to the battery design or soldering requirements.

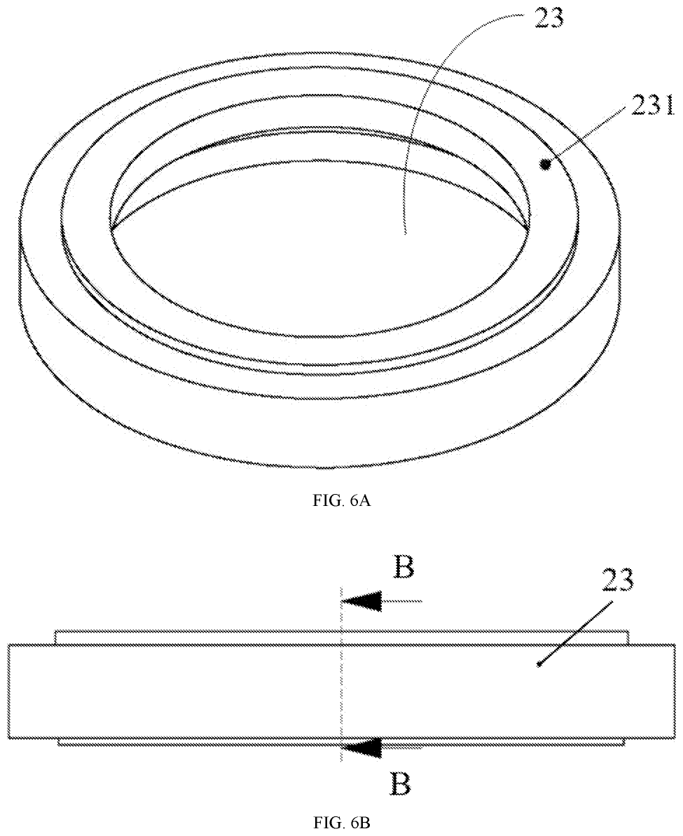

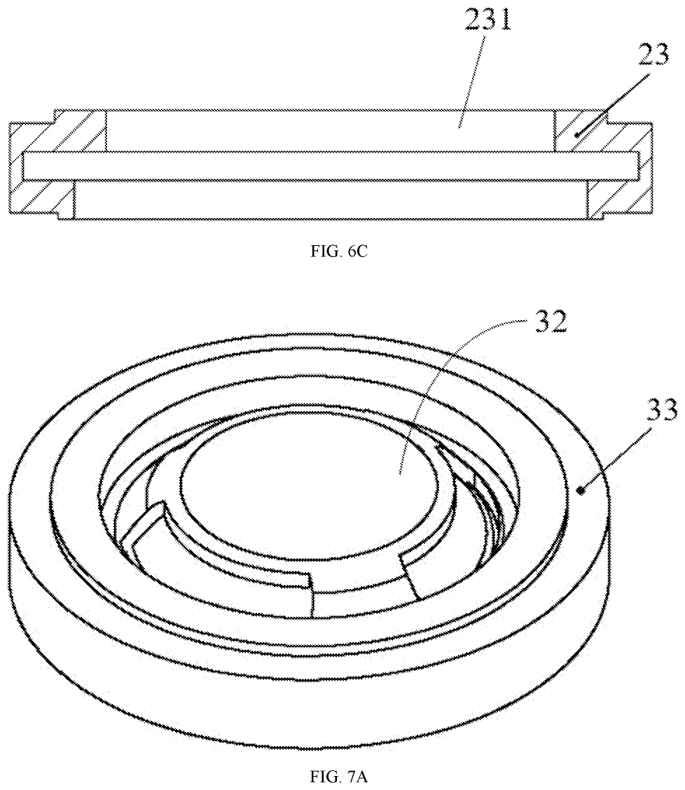

Please refer to FIG. 6A, FIG. 6B, and FIG. 6C, which are schematic diagrams of the insulating sleeve according to an embodiment of the present disclosure, wherein FIG. 6A is a three-dimensional view of the insulating sleeve, FIG. 6B is a side view of the insulating sleeve, and FIG. 6C is a cross-sectional view of the insulating sleeve along the dotted line B in FIG. 6B. As shown in the figure, the insulating sleeve 23 is a ring-shaped structure, which is made of heat-resistant insulating material, and an accommodation space 231 for placing the battery header is provided inside the insulating sleeve 23; after the battery header is covered, the insulating sleeve 23 is bonded to the battery header by thermal pressing, thus forming the header insulating sleeve set; the details are described in the following embodiments. The outer diameter of the header insulating sleeve set depends on the outer diameter of the insulating sleeve 23, which may correspond to the size of the case opening, allowing the battery header to be disposed inside the case opening for the following shrinking and sealing process.

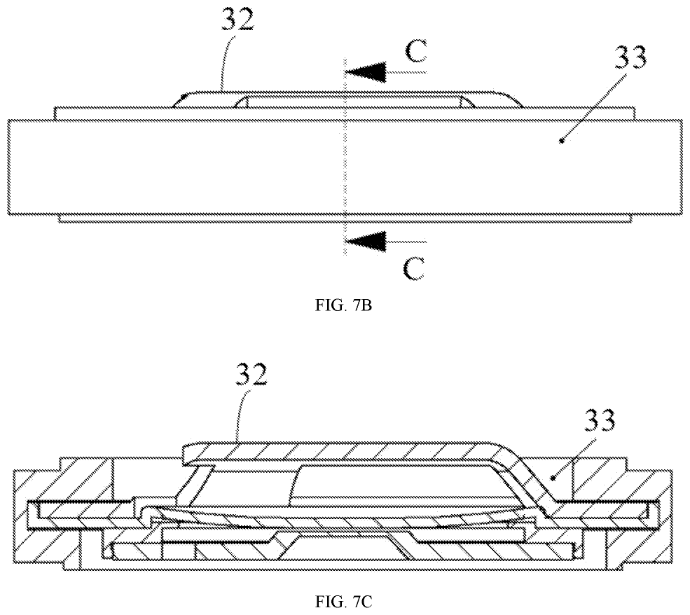

Please refer to FIG. 7A, FIG. 7B, and FIG. 7C, which are schematic diagrams of the header insulating sleeve set according to the embodiment of the present disclosure, wherein FIG. 7A is a three-dimensional view of the header insulating sleeve set, FIG. 7B is a side view of the header insulating sleeve set, and FIG. 7C is a cross-sectional view of the header insulating sleeve set along the dotted line C in FIG. 7B. As shown in the figure, as described in the aforementioned embodiment of the insulating sleeve, the insulating sleeve 33 may be sleeved on the battery header 32, covering the metal surface of the battery header 32 and forming the header insulating sleeve set by thermal pressing. In the header insulating sleeve set, the metal surface of the battery header 32 is covered by the insulating set 33 to achieve the sealing and insulating effect; when the entire header insulating sleeve set is disposed at the case opening, the header insulating sleeve set is fixed to the top of the battery through the shrinking and sealing process. The insulating sleeve 33 prevents the end of the case from contacting the battery header during the shrinking and sealing process, and the sealed structure may also prevent the risk of battery leakage.

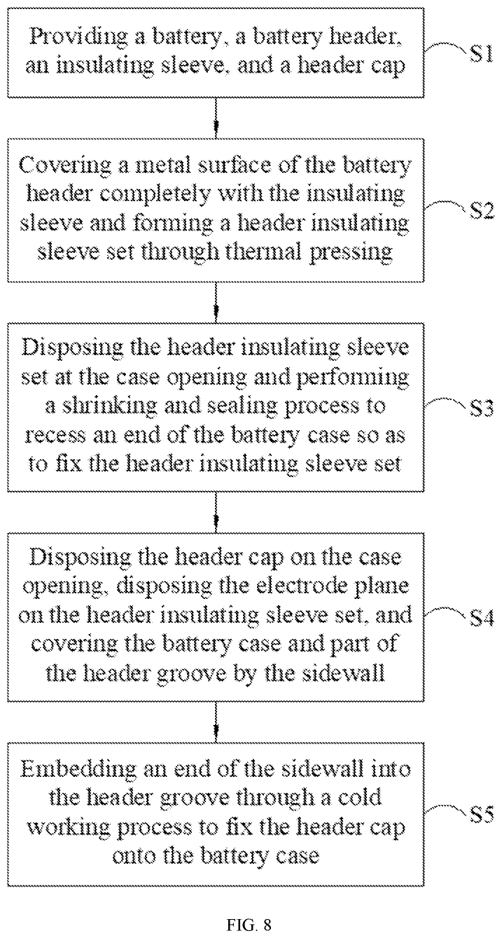

Please refer to FIG. 8, which is a flowchart of the assembly method of the battery header cap according to an embodiment of the present disclosure. As shown in the figure, the assembly method of the battery header cap includes the following steps (S1˜S5):

Step S1: providing a battery, a battery header, an insulating sleeve, and a header cap. The battery includes a battery body and a battery case, the battery body is disposed inside the battery case through a case opening, and the battery case has a header groove near the case opening; the battery header has a metal electrode and a metal surface electrically connected to the metal electrode. The header cap includes an electrode plane and a sidewall, the electrode plane has a header cap opening, and the sidewall is vertically connected to the end of the electrode plane. For the structures of the battery, the battery header, the insulating sleeve, and the header cap, please refer to the aforementioned embodiments, and the same description shall not be repeatedly illustrated herein.

Step S2: covering a metal surface of the battery header completely with the insulating sleeve and forming a header insulating sleeve set through thermal pressing. The insulating sleeve made of heat-resistant insulating material completely covers the metal surface of the battery header, that is, the part outside the battery header; the header insulating sleeve set that includes the insulating sleeve and the battery header is formed by bonding through the thermal pressing process. The header insulating sleeve set fits into the battery case opening according to the outer diameter of the insulating sleeve.

Step S3: disposing the header insulating sleeve set at the case opening and performing a shrinking and sealing process to recess an end of the battery case so as to fix the header insulating sleeve set. The shrinking and sealing process is required when the header insulating sleeve set is disposed at the case opening, the diameter of the shoulder of the header may be adjusted at the same time so as to achieve the requirement for a full battery closure, and the shrinking and sealing process allows the end of the battery case to be recessed into the insulating sleeve and tightly fastened to the entire header insulating sleeve set, making the top end of the battery completely sealed. In addition, the case electrode is insulated from the battery header through the insulating sleeve to avoid the risk of a short circuit caused by high-temperature operation during the follow-up soldering process.

Step S4: disposing the header cap on the case opening, disposing the electrode plane on the header insulating sleeve set, and covering the battery case and part of the header groove by the sidewall. After the aforementioned shrinking and sealing process, the header cap is further disposed on the case opening, the electrode plane of the header cap is disposed on the insulating sleeve and is in contact with the battery case, and the case electrode with a smaller area at the end of the original battery case is replaced by the electrode plane. The sealing of the electrode plane and the insulating sleeve may also increase the sealability of the battery header to prevent liquid leakage from the header. The center of the electrode plane is provided with an opening; when the header cap is disposed on the case opening, the metal electrode originally protruding from the header insulating sleeve set may be exposed through the opening; meanwhile, the height of the header cap is not higher than that of the metal electrode; that is, the disposition of the header cap may not affect the height of the battery itself, thus avoiding the inability to meet the needs of the disposition of a battery module in terms of the volume or specification.

Step S5: embedding an end of the sidewall into the header groove through a cold working process to fix the header cap onto the battery case. When the aforementioned header cap is disposed on the case opening, the sidewall of the header cap is sleeved on the battery case; in this step, the end of the sidewall is further embedded into the groove on the header groove through the cold working process, such as pressing and bending, to further fix the structure of the header cap. In addition to increasing the support of the fixation, under the circumstance of abnormal combustion and explosion of a battery generated during operation, the fixed header cap may enhance the fixing force of the header to prevent the risk of the header being ejected.

In other embodiments, the battery header cap may further include a follow-up soldering process; several batteries are connected in series and parallel through one or more electrode connecting pieces to form the required battery module. These electrode connecting pieces are used to solder metal electrodes to electrode planes through same-side plane soldering; since the electrode plane has a flatter surface and larger soldering area than the original case electrode, the soldering process may improve process efficiency and production quality, which is beneficial to enhance the productivity and yield rates of automated production of battery modules. In addition, the electrode plane may be adjusted according to a special structural design; for instance, a raised edge or a bump is disposed to allow electrode connecting pieces to be soldered to these special structures, increasing the need for soldering joints or other mechanical designs.

The above description is merely illustrative rather than restrictive. Any equivalent modifications or alterations without departing from the spirit and scope of the present disclosure are intended to be included in the following claims.

What is claimed is:

1. A battery header cap, comprising:
a battery comprising a battery body and a battery case, the battery body being disposed inside the battery case through a case opening, and the battery case having a header groove near the case opening;
a battery header disposed at the case opening, the battery header having a metal electrode and a metal surface electrically connected to the metal electrode;
an insulating sleeve completely covering the metal surface of the battery header, the outer diameter of the insulating sleeve corresponding to a size of the case opening; and
a header cap comprising an electrode plane and a sidewall, the electrode plane having a header cap opening to expose the metal electrode, the sidewall being vertically connected to an end of the electrode plane, the electrode plane being disposed on the insulating sleeve, the sidewall covering an end of the battery case, and an end of the sidewall being embedded into the header groove.

2. The battery header cap according to claim 1, wherein the electrode plane is disposed with a raised edge at an edge of the header cap opening, and the raised edge extends in an opposite direction of the header cap opening.

3. The battery header cap according to claim 1, wherein a bump is disposed on the electrode plane, and the bump is disposed between an end of the header cap and the header cap opening.

4. The battery header cap according to claim 1, wherein the battery case is a cylindrical case.

5. The battery header cap according to claim 1, wherein the electrode plane is connected to the battery case, which has an opposite polarity to the metal electrode.

6. An assembly method of a battery header cap, comprising following steps:
providing a battery, a battery header, an insulating sleeve, and a header cap, the battery comprising a battery body and a battery case, the battery case having a header groove near a case opening, and the header cap comprising an electrode plane and a sidewall;
covering a metal surface of the battery header completely with the insulating sleeve and forming a header insulating sleeve set through thermal pressing;
disposing the header insulating sleeve set at the case opening and performing a shrinking and sealing process to recess an end of the battery case so as to fix the header insulating sleeve set;
disposing the header cap on the case opening, disposing the electrode plane on the header insulating sleeve set, and covering the battery case and part of the header groove by the sidewall; and
embedding an end of the sidewall into the header groove through a cold working process to fix the header cap onto the battery case.

7. The assembly method of the battery header cap according to claim 6, wherein the electrode plane is disposed with a raised edge at an edge of a header cap opening of the header cap, and the raised edge and the electrode plane are soldered to an electrode connecting piece.

8. The assembly method of the battery header cap according to claim 6, wherein a bump is disposed on the electrode plane, and the bump and the electrode plane are soldered to an electrode connecting piece.

9. The assembly method of the battery header cap according to claim 6, wherein the battery body is disposed inside the battery case of a cylindrical case.

10. The assembly method of the battery header cap according to claim 6, wherein by adjusting a height of the electrode plane, the cold working process makes the height of the electrode plane no higher than that of a metal electrode of the battery header.
